(19) United States
(12) Patent Application Publication
(10) Pub. No.: US 2024/0149475 A1
(43) Pub. Date: May 9, 2024

(54) JOINT DEVICE AND ROBOT APPARATUS

(71) Applicant: FANUC CORPORATION, Yamanashi (JP)

(72) Inventor: Wataru AMEMIYA, Yamanashi (JP)

(21) Appl. No.: 18/280,790

(22) PCT Filed: Apr. 6, 2022
(86) PCT No.: PCT/JP2021/014648

§ 371 Date: Sep. 7, 2023

(51) Int. Cl. B25J 19/00; B25J 9/04; B25J 9/10; B25J 13/08

(52) U.S. Cl. CPC B25J 19/0004; B25J 9/047; B25J 9/102; B25J 13/087; B25J 19/021

(57) ABSTRACT

A joint device according to one aspect of the present disclosure is provided with an output shaft pivotally supported by a first link and connected to a second link, a rotary drive source provided in the first link, a first transmission mechanism that transmits the rotational force of the rotary drive source to the output shaft, a braking shaft provided in the first link, a second transmission mechanism that transmits the rotation of the output shaft to the braking shaft separately and independently from the first transmission mechanism, and a brake that brakes the rotation of the braking shaft.

### TECHNICAL FIELD

This disclosure described herein relate generally to a joint device and a robot apparatus.

### BACKGROUND ART

There is known a mechanism in which power generated by a drive source such as a motor is transmitted to a joint shaft of a robot by a transmission mechanism such as a belt, a gear, or the like. In such a mechanism, if a failure occurs in the transmission mechanism such as a breakage of the belt or damage to the gear, it becomes impossible to apply torque to the joint shaft. When a failure occurs in a transmission mechanism in a joint device having a rotational axis orthogonal to the direction of gravity, a structure on the rotation side of the joint device may fall due to its own weight, and the robot, a hand mounted on the robot, and workpieces and peripheral devices such as a jig around the robot may be damaged. In the case of collaborative robots, coexisting workers may be harmed. In order to avoid such a situation, Patent Literature 1 discloses a configuration in which an output shaft is provided with a brake mechanism.

### CITATION LIST

### Patent Literature

Patent Literature 1: Japanese Unexamined Patent Application Publication No. 2010-142895

However, in the configuration disclosed in Patent Literature 1, the output shaft is directly coupled to the brake, which reduces the degree of freedom of the mounting position of the brake, and when the output shaft is hollow, the brake becomes large.

### BRIEF DESCRIPTION OF THE DRAWINGS

FIG. 1 is an external view showing an example of a robot apparatus including a joint device according to the present embodiment.

FIG. 2 is a front view showing the internal structure of the joint device according to the present embodiment.

FIG. 3 is a side view showing the internal structure of the joint device shown in FIG. 2.

FIG. 4 is a configuration diagram of the robot apparatus including the joint device according to the present embodiment.

FIG. 5 is a front view showing the internal structure of another example of the joint device according to the present embodiment.

FIG. 6 is a front view showing the internal structure of another example of the joint device according to the present embodiment.

FIG. 7 is a diagram showing another example of a brake of the joint device according to the present embodiment.

### DETAILED DESCRIPTION

A joint device according to one aspect of the present disclosure is provided with an output shaft pivotally supported by a first link and connected to a second link, a rotary drive source provided in the first link, a first transmission mechanism that transmits the rotational force of the rotary drive source to the output shaft, a braking shaft provided in the first link, a second transmission mechanism that transmits the rotation of the output shaft to the braking shaft separately and independently from the first transmission mechanism, and a brake that brakes the rotation of the braking shaft.

Hereinafter, a joint device according to the present embodiment will be described with reference to the drawings. The joint device is composed of a joint mechanism, which is a structural part, and a joint controller which controls the joint mechanism. The joint mechanism can be used alone or as a joint of a robot arm mechanism or the like. In the present embodiment, the joint mechanism constituting the joint device is applied to a joint of a robot arm mechanism, and a control device for controlling the robot arm mechanism has a function as the joint controller constituting the joint device. In the following description, constituent elements having substantially the same function and configuration are denoted by the same reference numeral, and repetitive descriptions will be given only where necessary.

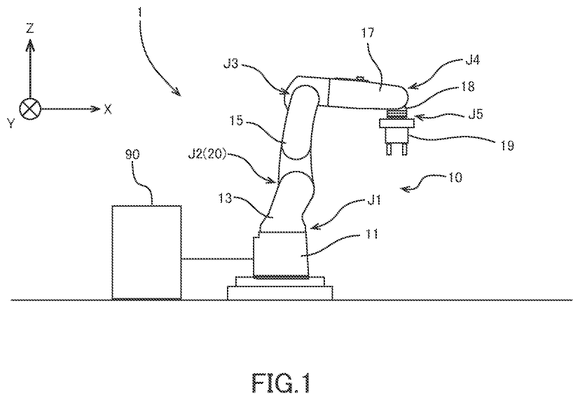

As shown in FIG. 1, a robot apparatus 1 including a joint device 20 according to the present embodiment includes a robot arm mechanism 10 and a control device 90 that controls the robot arm mechanism 10.

The robot arm mechanism 10 includes a base 11, a first link 13 connected to the base 11 via a joint J1, a second link 15 connected to the first link 13 via a joint J2, a third link 17 connected to the second link 15 via a joint J3, a fourth link 18 connected to the third link 17 via a joint J4, and an end effector 19 connected to the fourth link 18 via a joint J5. The joint J1 is a rotary joint having a rotation axis parallel to the direction of gravity. Each of the joint J2, the joint J3, and the joint J4 is a rotary joint having a rotation axis orthogonal to the direction of gravity. The joint J5 is a rotary joint having a rotation axis orthogonal to the rotation axis of the joint J4. In the present embodiment, among the three orthogonal axes, the axis parallel to the rotation axis of the joint J1 is defined as a Z axis, the axis parallel to the rotation axes of the joint J2, the joint J3, and the joint J4 is defined as a Y axis, and the axis orthogonal to the Y axis and the Z axis is defined as an X axis. When the robot arm mechanism 10 is placed on a horizontal surface, the Z axis (rotation axis of the joint J1) is parallel to the direction of gravity.

The structural part of the joint device 20 is applied to the joint J2, which connects the first link 13 and the second link 15. Of course, the structural part of the joint device 20 can be applied to the joints J1, J3, J4, and J5 other than the joint J2.

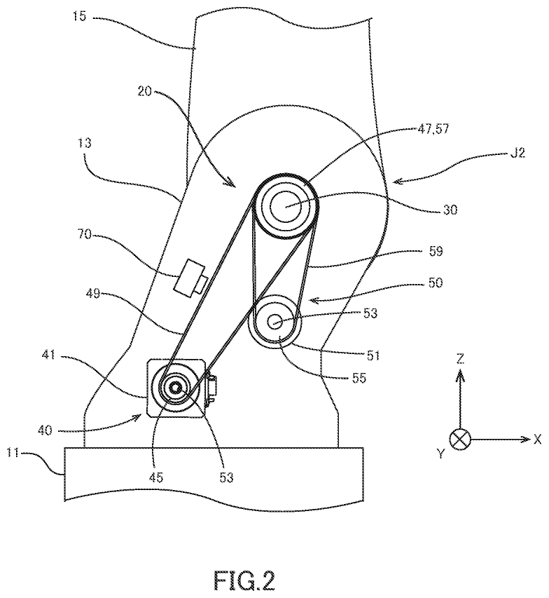

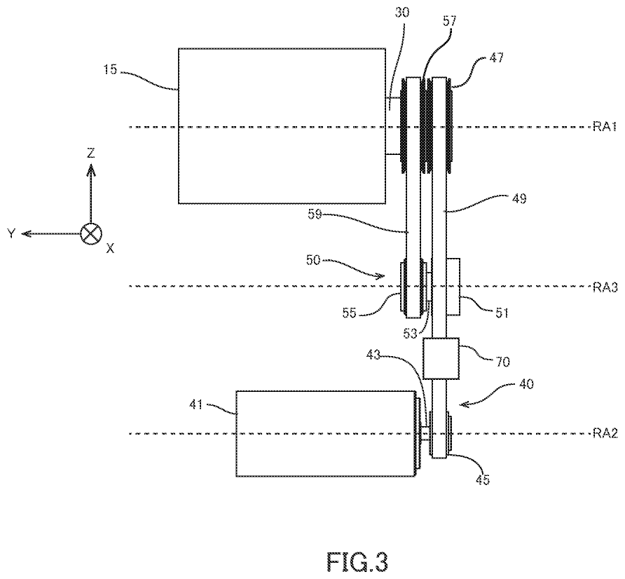

As shown in FIG. 2 and FIG. 3, the joint device 20 has an output shaft 30 pivotally supported by the first link 13 and connected to the second link 15, a drive mechanism 40 provided in the first link 13 to drive the rotation of the output shaft 30, a braking mechanism 50 provided in the first link 13 to brake the rotation of the output shaft 30, and a breakage detection sensor 70 that detects a breakage of a drive belt 49 constituting the drive mechanism 40.

The output shaft 30 is rotatably provided on the first link 13 via a bearing or the like such that its rotation axis RA1 is parallel to the Y axis. Two pulleys 47 and 57 are coupled to an end portion of the output shaft 30 in the first link 13. The pulley 47 around which the drive belt 49 is wound is referred to as a first output pulley 47, and the pulley 57 around which the braking belt 59 is wound is referred to as a second output pulley 57 for distinction. Of course, the two pulleys 47 and 57 may be replaced by a single pulley having two belt grooves.

The drive mechanism 40 includes a motor unit 41. The motor unit 41 includes a servo motor (rotary drive source) that generates power to rotate the output shaft 30 and a reduction gear that reduces the rotation of the motor. The motor unit 41 is provided at a position offset from the output shaft 30 in the XZ plane in such an orientation that the rotation axis RA2 of the drive shaft 43 is parallel to the Y axis. A drive pulley 45 is coupled to the drive shaft 43. The drive pulley 45 has one belt groove. An endless drive belt 49 is stretched with a constant tension between the drive pulley 45 and the first output pulley 47. The drive pulley 45, the first output pulley 47, and the drive belt 49 constitute a first transmission mechanism that transmits the rotational force of the motor unit 41 to the output shaft 30.

The braking mechanism 50 has a shaft (braking shaft 53) rotatably provided on the first link 13. The braking shaft 53 may be pivotally supported by the first link 13, or may be rotatably supported via a bearing or the like on a member provided on the first link 13, such as an electromagnetic brake 51. The braking shaft 53 is provided at a position offset from the output shaft 30 in the XZ plane in such a orientation that its rotation axis RA3 is parallel to the Y axis. A braking pulley 55 is coupled to one end of the braking shaft 53. The braking pulley 55 has one belt groove. An endless braking belt 59 is stretched with a constant tension between the braking pulley 55 and the second output pulley 57. An electromagnetic brake 51 is provided at the other end of the braking shaft 53. For example, the electromagnetic brake 51 may be of a type that brakes the rotation of the braking shaft 53 when not energized and releases the braking shaft 53 when energized. When not energized, the electromagnetic brake 51 presses a friction braking member against the braking shaft 53 with a solenoid so as to brake the rotation of the braking shaft 53 by friction. The braking pulley 55, the second output pulley 57, and the braking belt 59 constitute a second transmission mechanism that transmits the rotational force of the output shaft 30 to the braking shaft 53.

The breakage detection sensor 70 detects a breakage of the drive belt 49. As the breakage detection sensor 70, typically, a reflection type photoelectric sensor can be used, which emits light such as visible light or infrared light from a light projecting unit and detects a change in the amount of light reflected by a detection target at a light receiving unit. The breakage detection sensor 70 is provided at a position facing the belt surface of the drive belt 49. When the amount of light received at the light receiving unit is equal to or less than a threshold value, the breakage detection sensor 70 outputs a detection signal indicating that an abnormality such as a breakage has occurred in the drive belt 49 to the control device 90.

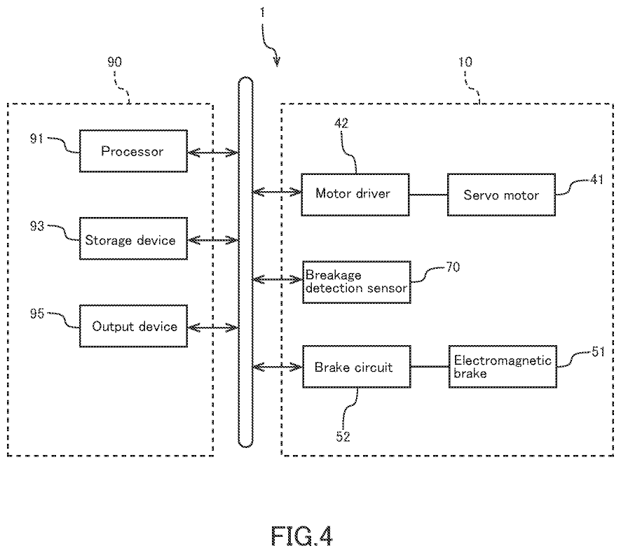

Hereinafter, a configuration of the robot apparatus 1 will be described with reference to FIG. 4.

The control device 90 of the robot apparatus 1 includes a processor 91. A storage device 93, an output device 95, a motor driver 42 of the joint device 20, a brake circuit 52 of the joint device 20, and the breakage detection sensor 70 are connected to the processor 91 via a data/control bus.

The output device 95 is a display device such as a liquid crystal display or an organic EL display. For example, the output device 95 displays, under the control of the processor 91, a notification screen for notifying that an abnormality such as a breakage has occurred in the drive belt 49. The output device 95 may be a speaker, a lamp, or the like as long as it can notify the operator that an abnormality has occurred in the drive belt 49.

The storage device 93 stores a robot control program for controlling the robot arm mechanism 10 and a brake control program for controlling the electromagnetic brake 51. The processor 91 generates a motor control command value such as a position command value, a speed command value, or a torque command value of each joint by executing the robot control program, and outputs the motor control command value to the motor driver 42. The motor driver 42 drives the motor in accordance with the motor control command value from the processor 91 while referring to the output of a rotary encoder (not shown) that detects the rotation angle of the rotation axis, rotation speed, rotation direction, and the like of the motor. Thus, the robot arm mechanism 10 operates in accordance with a sequence defined by the robot control program.

By executing the brake control program, the processor 91 generates a switch command value for switching the electromagnetic brake 51 from an energized state to a non-energized state based on the detection signal having been output from the breakage detection sensor 70, and outputs the switch command value to the brake circuit 52. The brake circuit 52 is, for example, an electric circuit constituted by a transistor or the like. The brake circuit 52 can supply brake power to the electromagnetic brake 51 in a normal state in which the drive belt 49 is not broken, and can cut off the supply of brake power based on the switch command value having been output from the processor 91. In the normal state, the electromagnetic brake 51 is energized, and the braking shaft 53 is maintained in a released state. In this state, the braking shaft 53 rotates in accordance with the rotation of the output shaft 30. When the drive belt 49 is broken, the electromagnetic brake 51 is switched from the energized state to the non-energized state to brake the rotation of the braking shaft 53. The braking force generated on the braking shaft 53 by the electromagnetic brake 51 is transmitted to the output shaft 30 via the second transmission mechanism. That is, when the rotation of the braking shaft 53 is braked, the rotation of the output shaft 30 connected to the braking shaft 53 via the second transmission mechanism is braked, and the second link 15 coupled to the output shaft 30 is stopped at the rotational position at the time the drive belt 49 is broken. Here, the electromagnetic brake 51 is used only when the drive belt 49 is broken, but the electromagnetic brake 51 may be used to decelerate the output shaft 30 in the normal state in which the drive belt 49 is not broken. The motor and the electromagnetic brake 51 cooperate with each other to decelerate the rotation of the output shaft 30 so that the motor load associated with the deceleration can be reduced.

According to the joint device 20 of the present embodiment described above, the first transmission mechanism that transmits the rotational force of the motor unit 41 to the output shaft 30 and the second transmission mechanism that transmits the rotational force of the output shaft 30 to the braking shaft 53 are separated and independent from each other, so that even if the drive belt 49 is broken, the output shaft 30 and the second link 15 coupled to the output shaft 30 can be braked by the braking mechanism 50, and the safety of the robot arm mechanism 10 can be improved.

By employing the configuration in which the rotational force of the motor unit 41 is transmitted to the output shaft 30 by the first transmission mechanism and the rotational force of the output shaft 30 is transmitted to the braking shaft 53 via the second transmission mechanism, the joint device 20 according to the present embodiment can offset the motor unit 41 (drive shaft 43) and the electromagnetic brake 51 (braking shaft 53) from the output shaft 30, and can improve the degree of freedom in mounting the motor unit 41 and the electromagnetic brake 51. Since the motor unit 41 and the electromagnetic brake 51 can be dispersed in the first link 13 with respect to the output shaft 30, an increase in the size of the joint part can be suppressed compared to a configuration in which the output shaft 30 is directly braked by the electromagnetic brake 51 or a configuration in which the output shaft 30 is directly driven. In particular, since the electromagnetic brake 51 does not act directly on the output shaft 30, even if the output shaft 30 is a relatively large hollow shaft, it is not necessary to increase the size of the electromagnetic brake 51, which makes it possible to suppress an increase in the size of the joint part by providing the braking mechanism 50.

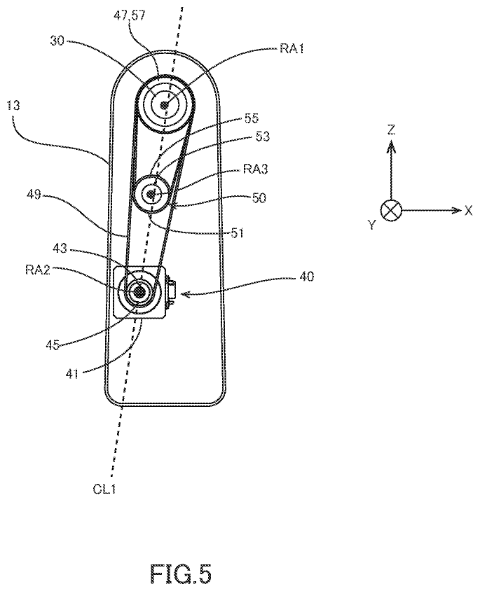

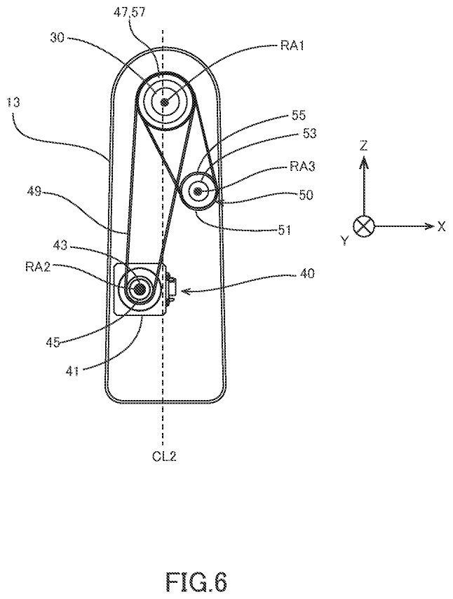

Hereinafter, the positional relationship of the electromagnetic brake 51 (braking shaft 53) and the motor unit 41 (drive shaft 43) with the output shaft 30 will be described with reference to FIG. 2, FIG. 5, and FIG. 6. Here, the positional relationship with respect to the XZ plane will be described.

As shown in FIG. 2, FIG. 5, and FIG. 6, from the viewpoint of expanding the movable range (rotational range) of the second link 15, it is desirable that the motor unit 41 is disposed on the same side of the output shaft 30 as the electromagnetic brake 51 and at a position farther than the electromagnetic brake 51 from the output shaft 30. When housed in the first link 13, the motor unit 41 is longer than the electromagnetic brake 51 in the Y-axis direction. By disposing the motor unit 41 at a position on the base 11 side far from the output shaft 30, the angular range in which the second link 15 interferes with the motor unit 41 can be narrowed, and the movable range (rotational range) of the second link 15 can be widened, as compared to the case where the motor unit 41 is disposed at a position close to the output shaft 30.

As shown in FIG. 5, from the viewpoint of suppressing an increase in the size of the first link 13, it is desirable that the electromagnetic brake 51 is disposed in a substantially oval area inside the track of the drive belt 49 when the joint device 20 is viewed from the front side (Y-axis direction). Specifically, it is desirable that the braking shaft 53 is disposed so that its rotation axis RA3 is on a straight line CL1 passing through the rotation axis RA1 of the output shaft 30 and the rotation axis RA2 of the drive shaft 43 and between the rotation axis RA1 of the output shaft 30 and the rotation axis RA2 of the drive shaft 43.

When the electromagnetic brake 51 cannot be disposed inside the track of the drive belt 49, it is desirable to dispose the electromagnetic brake 51 (braking shaft 53) outside the track of the drive belt 49 and at a position as close as possible to the drive belt 49 as shown in FIG. 2.

Further, when the electromagnetic brake 51 cannot be disposed inside the track of the drive belt 49, it is desirable to dispose the motor unit 41 inside the first link 13 close to one side of a center line CL2 which is parallel to the longitudinal direction of the first link 13 and passes through the width center of the first link 13, and dispose the electromagnetic brake 51 close to the other side of the center line CL2, as shown in FIG. 6. Specifically, the motor unit 41 is disposed at a position where its rotation axis RA2 is offset to one side (−X direction side) of the center line CL2 of the first link 13, and the electromagnetic brake 51 is disposed at a position where the rotation axis RA3 of the braking shaft 53 is offset to the other side (+X direction side) of the center line CL2 of the first link 13. This suppresses an increase in the size of the first link 13 caused by providing the braking mechanism 50, while avoiding interference between the drive belt 49 and the electromagnetic brake 51.

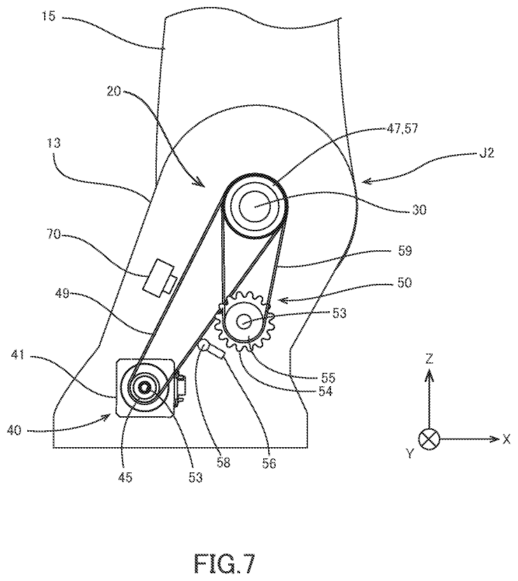

In the present embodiment, the electromagnetic brake 51 is used to brake the rotation of the braking shaft 53, but the type of the brake is not limited to the electromagnetic brake as long as the rotation of the braking shaft 53 can be braked. For example, the brake may be of a mechanical type that brakes the rotation of the braking shaft 53 by causing another member to collide with a rotating member coupled to the braking shaft 53. As shown in FIG. 7, the brake includes a disc 54 coupled to the braking shaft 53 and an engaging arm 56. A plurality of engaging recesses are formed in the outer edge of the disc 54. The engaging arm 56 is disposed at a position where its distal end is away from the disc 54 in the normal state in which the drive belt 49 is not broken, and when the drive belt 49 is broken, the distal end moves toward the disc 54. For example, a roller 58 that freely rotates in contact with the drive belt 49 is coupled to the proximal end of the engaging arm 56. The roller 58 is pivotally supported by the first link 13. The distal end of the engaging arm 56 is urged toward the disc 54 by a spring member such as a plate spring or an elastic resin member such as silicon rubber. In the normal state in which the drive belt 49 is not broken, in other words, in a state in which the roller 58 is rotated by the drive belt 49, the distal end of the engaging arm 56 is separated from the disc 54 against the urging force, and the braking shaft 53 is released from braking by the brake. When the drive belt 49 is broken, in other words, when the rotation of the roller 58 is stopped, the distal end of the engaging arm 56 is urged toward the disc 54 and engages with the recesses of the disc 54. Thereby, the rotation of the braking shaft 53 is braked. This configuration eliminates the need for the breakage detection sensor 70, and eliminates the need to route a cable or the like to the brake since the brake need not be electrically controlled. Of course, any electric component such as a motor may be used as a drive source for driving the engaging arm 56, and the engaging arm 56 may be driven by electric control based on the detection of a breakage of the drive belt 49 by the breakage detection sensor 70.

Although a photoelectric sensor is used as the breakage detection sensor 70 in the present embodiment, the breakage detection sensor 70 is not limited to this as long as it can detect at least a breakage of the drive belt 49. For example, as a sensor for detecting an abnormality of the drive belt 49, it is possible to use a device that urges a roller toward the drive belt 49, brings the roller into pressure contact with the belt surface of the drive belt 49, monitors a change in the position of the shaft of the roller, and detects the tension of the drive belt 49 from the change in the position of the shaft of the roller. Alternatively, as a sensor for detecting an abnormality of the drive belt 49, it is possible to use a sonic belt tension meter capable of sensing an acoustic wave (natural frequency) generated by the drive belt 49 and measuring the tension of the drive belt 49. The above-described two types of devices can detect not only a breakage of the drive belt 49 but also an abnormality such as a slack in the drive belt 49. When either of the above two devices is used instead of the breakage detection sensor 70, the processor 91 outputs a switch command value to the brake circuit 52 to operate the electromagnetic brake 51 when a breakage or slack of the drive belt 49 is detected by the sensor. Since the drive belt 49 can be replaced when a slack of the drive belt 49 is detected, the risk of structural components inside the first link 13 being damaged by the broken drive belt 49 can be suppressed.

It is noted that, if the drive belt 49 is slightly loosened, it may be used as it is. Therefore, the sensor may be configured to distinguish the breakage and the slack of the drive belt 49 at the time of detection, and the processing when a breakage of the drive belt 49 is detected may be differentiated from the processing when a slack of the drive belt 49 is detected, such as, when a breakage of the drive belt 49 is detected, operating the electromagnetic brake 51 and notifying the operator of the breakage of the drive belt 49 via the output device 95, and when a slack of the drive belt 49 is detected, not operating the electromagnetic brake 51 but notifying the operator of the slack of the drive belt 49 via the output device 95. For example, by replacing the drive belt 49 when a series of tasks by the robot arm mechanism 10 are completed, instead of replacing the drive belt 49 immediately when a slack is detected, a decrease in the work efficiency of the robot arm mechanism 10 can be suppressed.

In the present embodiment, the breakage of the drive belt 49 is detected by directly monitoring the drive belt 49 with the breakage detection sensor 70, but the configuration is not limited to the above as long as the breakage of the drive belt 49 can be detected. When the drive belt 49 is broken, the rotational force of the motor is not transmitted to the output shaft 30, resulting in a difference between the rotational speed of the drive shaft 43, which is calculated from the rotational speed of the motor and the reduction ratio of the reduction gear, and the rotational speeds of the output shaft 30 and the braking shaft 53. Based on this difference, the breakage of the drive belt 49 can be detected. In this case, for example, the braking shaft 53 can be provided with, for example, an encoder as a position detection unit for detecting the rotational position of the braking shaft 53, and the breakage of the drive belt 49 can be detected based on the output value of the encoder and the rotational speed of the motor.

Alternatively, when the drive belt 49 is broken, the torque applied to the shaft of the motor, the drive shaft 43, and the output shaft 30 is reduced; therefore, the breakage of the drive belt 49 can be detected by monitoring the amount of change in the torque with a torque sensor or the like.

In the present embodiment, a belt mechanism is employed as the first transmission mechanism for transmitting the rotational force of the motor to the output shaft 30, and a belt mechanism is employed as the second transmission mechanism for transmitting the rotational force of the output shaft 30 to the braking shaft 53, but as one transmission mechanism or both transmission mechanisms, a gear mechanism formed by combining a plurality of gears may be employed, or a mechanism formed by combining a gear and a belt may be employed. Even when the transmission mechanism is a gear mechanism, the same effect as in the case where the transmission mechanism is constituted by a belt mechanism can be obtained. Similar to when the drive belt 49 is broken, if an abnormality such as chipping of a gear constituting the first transmission mechanism occurs and the rotational force of the motor cannot be transmitted to the output shaft 30, it is possible that the second link 15 cannot be braked and fall. This can be prevented by a configuration for detecting an abnormality of the first transmission mechanism and operating the electromagnetic brake 51 when an abnormality of the first transmission mechanism is detected. For example, the abnormality of the first transmission mechanism can be detected by using the rotational speed of the motor and the rotational speed of the braking shaft 53 (output shaft 30) as already described.

In the present embodiment, only the drive belt 49 is monitored, but the braking belt 59 may also be monitored along with the drive belt 49. In this case, the breakage of the braking belt 59 can be detected by using another breakage detection sensor identical to the breakage detection sensor 70. When the breakage of the braking belt 59 is detected by the other breakage detection sensor, the motor driver 42 stops driving the motor in accordance with a command from the processor 91. Thus, the second link 15 is braked at the position where it was when the braking belt 59 was broken. Although the mere breakage of the braking belt 59 does not affect the driving of the second link 15, if the drive belt 49 is also broken in the state where the braking belt 59 is broken, the second link 15 cannot be braked. Therefore, the safety of the robot arm mechanism 10 can be further improved by stopping the rotation of the output shaft 30 by motor control when a breakage of the braking belt 59 is detected.

The drive belt 49 and the braking belt 59 are preferably designed so that the life of the braking belt 59 is longer than that of the drive belt 49. In order to make the life of the braking belt 59 longer than that of the drive belt 49, the braking belt 59 is made of a thicker member than the drive belt 49. Of course, the present disclosure is not limited to this, and the braking belt 59 may be made of a material having high rigidity. If the drive belt 49 and the braking belt 59 are replaced at the same time at the time of maintenance, even if the drive belt 49 is broken due to factors such as aging degradation, the braking belt 59, which has a longer life than the drive belt 49, is likely to be normal. Reducing the possibility of the braking belt 59 breaking before the drive belt 49 breaks eliminates the need for another breakage detection sensor to detect the breakage of the braking belt 59, while still providing the same level of safety as when the braking belt 59 is monitored by another breakage detection sensor.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

1. A joint device for coupling a first link to a second link of a robot, comprising:
an output shaft pivotally supported by the first link and connected to the second link;
a rotary drive source provided in the first link;
a first transmission mechanism configured to transmit a rotational force of the rotary drive source to the output shaft;
a braking shaft provided in the first link;
a second transmission mechanism configured to transmit a rotational force of the output shaft to the braking shaft separately and independently from the first transmission mechanism; and
a brake configured to brake rotation of the braking shaft.

2. The joint device according to claim 1, wherein the first transmission mechanism is a belt mechanism.

3. The joint device according to claim 1, wherein the second transmission mechanism is a belt mechanism.

4. The joint device according to claim 1, wherein the second transmission mechanism is a gear mechanism.

5. The joint device according to claim 1, wherein the brake is an electromagnetic brake.

6. The joint device according to claim 1, further comprising:
a sensor configured to detect an abnormality of the first transmission mechanism; and
a control unit configured to control the brake based on an output of the sensor.

7. The joint device according to claim 1, wherein the rotary drive source is disposed on a same side of the output shaft as the brake and at a position farther than the brake from the output shaft.

8. The joint device according to claim 1, wherein the rotary drive source is disposed close to one side of a center line of the first link, and the brake is disposed close to another side of the center line of the first link.

9. A robot apparatus comprising the joint device according to claim 1.
